(19) United States
(12) Patent Application Publication
(10) Pub. No.: US 2013/0224404 A1
(43) Pub. Date: Aug. 29, 2013

(54) ISOCYANATE-FREE INSULATED GLASS SEALANT AND INSULATED GLASS UNITS USING THE SAME

(71) Applicants: Herbert Shin-I Chao, Paoli, PA (US); Nan Tian, Wilmington, DE (US)

(72) Inventors: Herbert Shin-I Chao, Paoli, PA (US); Nan Tian, Wilmington, DE (US)

(73) Assignee: CRAY VALLEY USA, LLC, Exton, PA (US)

(21) Appl. No.: 13/407,110

(22) Filed: Feb. 28, 2012

(51) Int. Cl. E06B 3/00; B29C 65/48; C09J 109/00

(52) U.S. Cl. 428/34; 524/571; 156/104

(57) ABSTRACT

An insulated glass sealant includes an elastomeric matrix that is the reaction product of an acetoacetylated polymer and a cross-linking reagent having amino functionality, preferably a polyetheramine, polyamine, or polyamide. A method of sealing an insulated glass unit includes applying the insulated glass sealant to one or more glass sheets, disposing a spacer between the glass sheets, and contacting the glass sheets with the spacer to define an annular space between the glass sheets to produce the insulated glass unit. The sealants maintain the excellent attributes of traditional polyurethane sealants, such as low water swell, low moisture vapor transmission, good adhesion to the window frame, low migration of the insulating gas, and good workability, but without the use of polyisocyanates in the curing process. Methods for making the sealant and sealing insulated glass panels, such as glass windows, with these sealants, and the resulting articles, are also provided.

### FIELD OF THE INVENTION

This invention relates generally to compositions which may be employed as insulated glass sealants and methods of manufacturing and utilizing such sealants in the construction of insulated glass units. Specifically, the invention relates to rugged sealants based on the reaction products of acetoacetyl functionalized polymers and cross-linking reagents with amino functionality. The sealants of the present invention maintain the excellent attributes of traditional polyurethane sealants, such as low water swell, low moisture vapor transmission, good adhesion to the window frame, low migration of the insulating gas, and good workability, but without the use of polyisocyanates in the curing process. Methods for sealing insulated glass panels, such as glass windows, with these rugged sealants, and the resulting articles, are also disclosed herein.

### BACKGROUND OF THE INVENTION

Insulated glass units (IGUs) generally comprise a pair of glass sheets, maintained in a spaced apart relationship to each other by a spacer assembly, and a sealing assembly which extends around the periphery of the inner facing surfaces of the glass sheets to define a sealed and insulating air space between the glass sheets. Typically, the spacer assembly is a hollow form which extends around the periphery of the inside facing surfaces of the glass sheets and which is filed with a water-absorbent material, such as a molecular sieve or another dehydration element, to keep the enclosed air space dry. The inner surfaces of the glass sheets are attached to the outer surface of the spacer assembly by means of a sealant or adhesive. Generally, the sealant or adhesive is also used to seal the edges of the insulated glass unit so as to establish a barrier which prevents moisture from penetrating into the interior annular space of the unit.

The sealant must have a combination of properties for satisfactory use. For example, the sealant must have a very low moisture vapor transmission (MVT) rate so that moisture is prevented from entering the dry annular space between the panes of glass. Moisture in such space tends to condense on the interior faces of the panes, creating visibility and aesthetic problems. If the sealant does not have a satisfactory MVT rate, the longevity of the insulated unit may be severely reduced. The sealant should have good elongation and flexibility so that it “yields” during contraction and expansion of the insulated glass structure, for example, to relieve stress on the glass caused by changes in temperature. The sealant desirably also forms an excellent bond with the glass which is not degraded over long periods of use when exposed to sunlight, moisture, and large temperature changes. Tensile adhesion strength is an important indicator of bond strength.

Two of the major types of sealants currently used in the insulated glass industry are: (A) thermoplastic one-part hot melt butyl type sealants, and (B) the chemically-curing thermoset sealant products generally from the generic families of polysulfide, polyurethane, and silicone. Hot melt butyl insulated glass sealants have been used with moderate success for a number of years in the insulated glass industry. However, there are significant shortcomings with this technology that have limited the application of hot melt butyl insulated glass sealants. Primarily, the hot melt butyl is a thermoplastic material, and not a thermoset material. Thermoplastic sealants are well known to soften when exposed to heat. Therefore, the insulated glass units sold in the marketplace which employ thermoplastic sealants are known to flow or deform, when placed under load, to relieve such stresses. This characteristic is exaggerated at high temperatures, which can occur in insulated glass units, especially those utilizing solar control glass. As a result, insulated glass units made with hot melt butyl sealants have difficulty passing stress and temperature tests common in industry, and are often limited for use in relatively small, light insulated glass units. Additionally, extreme care must be taken to support the insulated glass unit during handling, shipping and installation, resulting in additional costs. Furthermore, the hot melt sealants previously employed must be applied to the insulated glass units at temperatures exceeding 300° F. These high temperature requirements often present increased manufacturing costs, for example due to higher energy consumption and the need for specialized high-temperature equipment, as well as operational and safety challenges. Attempts to utilize lower temperature hot melts have been known to cause flow problems with the sealant.

The thermoset products which are currently used are generally two-component sealants which are mixed at the point of application at room temperature. The sealants then cure slowly by reaction with a supplied catalyst or through reaction with moisture. This slow cure requires that the insulated glass units be held in inventory from several hours to days waiting for the sealant to harden. Several single-component sealants are also available in the marketplace, such as those which include a partially cross-linked hot melt butyl rubber sealant. These single-component sealants, however, generally require treatment at elevated temperatures from about 325° F. to about 425° F. to crosslink the sealant. Other sealants employed in the art utilize urethane-curing chemistry, which is unsuitable for insulated glass industry because the carbon dioxide (CO₂) generated in the process as bubbles can get trapped at the interface of the sealant and the glass which detrimentally affect the visibility and aesthetics of the insulated glass unit.

More recently, sealants based on polyurethane chemistry have been used for insulated glass units and there is a demand to explore the feasibility of such sealants for this application due to their potential to eliminate the shortcomings of the hot melt butyl and thermoset sealant products discussed above. These polyurethane-based sealants employ polyols, such as hydroxyl-terminated polybutadiene, to react with isocyanate to form a sealant. However, such sealants have environmental and safety concerns due to the utilization of isocyanates. As known to one having ordinary skill in the art, isocyanates are a family of highly reactive, low molecular weight chemicals. Isocyanates are powerful irritants to the mucous membranes of the eyes and gastrointestinal and respiratory tracts. Direct skin contact can also cause marked inflammation. Prolonged exposure can also sensitize workers, making them subject to severe asthma attacks or death if they are exposed again. Accordingly, compositions which have the beneficial properties of known insulated glass sealants, without the harmful safety concerns or detrimental by-products are highly desirable.

### SUMMARY OF THE INVENTION

It has now been found that the reaction products of reacting acetoacetyl functionalized polymers with cross-linking reagents with amino functionality, preferably polyetheramines, polyamines, and polyamides, provide rugged sealants for use in insulated glass applications. The sealants of the present invention maintain the excellent attributes of traditional polyurethane sealants, such as those based on the reactions of hydroxyl-terminated polybutadiene and isocyanates, including low water swell, low moisture vapor transmission, good adhesion to the window frame, low migration of the insulating gas, and good workability, but without the use of isocyanates in the curing process. Because the present sealant employs compatible compositions which solidify at different rates and through different mechanisms, the sealant can be applied at a lower temperature than traditional hot melts, and also provides sufficient handling strength to the unit faster than traditional chemical-cure products, thereby combining the best properties of both the hot melt and chemically-curing technologies into a successful sealant for the insulated glass industry. The sealant of the present invention is designed to be applied at temperatures in the range of 70°-300° F., in the form of a liquid or paste which turns to a solid upon curing. These and other advantages of the present invention will be readily apparent from the description, the discussion, and examples which follow.

It has further been found that the sealants may be applied to the panels of insulated glass units, such as at the edges of the panels, to adhere the components of the units together and, thereby, sealing the unit from subsequent moisture penetration. Most specifically, the present invention relates to a one-component edge sealant for insulated glass units which may be applied as a liquid or paste at an elevated temperature. The sealant is capable of then reversibly and rapidly solidifying upon cooling and, thereafter, irreversibly solidifying upon exposure to ambient atmospheric conditions. Accordingly, the present invention relates to the sealants, methods for sealing insulated glass panels such as glass windows with the sealants, and the resulting insulated glass unit articles.

In a first embodiment of the present invention, an insulated glass sealant comprises an elastomeric matrix that is the reaction product of an acetoacetyl functionalized polymer and a cross-linking reagent with amino functionality, preferably a polyetheramine, polyamine, or polyamide. The elastomeric matrix is not a gel but rather is harder and more elastomeric (rubbery) than a gel. For example, the relative ratios of the reactants and the reaction/processing conditions are selected to provide an elastomeric matrix having a Shore A hardness at 25° C. of at least about 30, at least about 35, at least about 40, at least about 45, or at least about 50. The sealant may further comprise one or more additives selected from the group consisting of inorganic fillers, plasticizers, and mixtures thereof. In at least one embodiment, the acetoacetyl functionalized polymer is hydrophobic. Suitable acetoacetyl functionalized polymers may be those which have a glass transition temperature (Tg) of less than about 32° F. (0° C.). The polymeric portion of the acetoacetyl functionalized polymer may, for example, be a homopolymer or copolymer of one or more diene monomers such as butadiene or isoprene or a copolymer of one or more diene monomers with one or more non-diene monomers such as styrene and/or acrylonitrile. Suitable cross linking reagents include, but are not limited to, polyetheramines, polyamines, and polyamides, and mixtures of two of more thereof. For example, suitable cross-linking reagents may have an average functionality equal to, or greater than, 2 (meaning that the cross-linking reagent contains at least two amino functional groups per molecule).

In another embodiment, the present invention relates to a method of sealing an insulated glass unit. The method includes applying the insulated glass sealant to one or more glass sheets, a spacer to be disposed between the glass sheets, or both; and contacting the one or more glass sheets with the spacer to define an annular space between the glass sheets and to produce the insulated glass unit. The sealant may be applied in a number of different methods using various equipment, as would be readily appreciated by an ordinarily skilled artisan. For example, the sealant may be applied as a bead to the one or more glass sheets, the spacer, or both. The method may further include the step of, prior to or concurrent with the contacting step, introducing an insulating gas into the annular space created between the first and second glass sheets. Exemplary insulating gases include argon or krypton.

In a further embodiment, the present invention relates to an insulated glass unit. The unit includes a first glass sheet having an inner surface and an outer surface; a second glass sheet having an inner surface and an outer surface, wherein the first and second glass sheets are positioned such that said inner surfaces of the glass sheets are facing one another; a spacer located between the first and second glass sheets, the spacer having a first side and a second side, with the first side of the spacer located adjacent the inner surface of the first glass sheet and the second side of the spacer located adjacent the inner surface of the second glass sheet; and an insulated glass sealant connecting the first and second glass sheets to the spacer. The first and second glass sheets and the spacer may be configured to provide an annular space between the glass sheets. The insulated glass unit may further include an insulating gas within the annular space.

As will be described in more detail below, the elastomeric matrix of the insulated glass sealants may be formed directly from the reaction of the acetoacetyl functionalized polymer and the cross-linking reagent having amino functionality. Alternatively, the elastomeric matrix may be formed by first reacting a hydroxyl-terminated polymer, such as hydroxyl-terminated polybutadiene with a diketene or diketene-acetone adduct to produce the acetoacetyl functionalized polymer; and then reacting the acetoacetyl functionalized polymer with the cross-linking reagent having amino functionality. As would be appreciated by one having ordinary skill in the art, a number of other reactants may be utilized within contemplation of this invention to produce acetoacetyl functionalized polymers in advance of the reaction with the cross-linking reagent having amino functionality.

### DETAILED DESCRIPTION OF THE INVENTION

The present invention is directed to compositions which may be employed as insulated glass sealants and methods of manufacturing and utilizing such sealants in the construction of insulated glass units. The purpose of the sealant is to provide structural integrity to the unit while sealing out moisture and preventing the exchange of gases. The edge sealant also resists environmental attack from water, UV, and temperature extremes.

Specifically, the invention relates to rugged sealants based on the reaction products of a cross-linking reagent having amino functionality, such as polyetheramines, polyamines, or polyamides, and acetoacetyl functionalized polymers, such as acetoacetylated polybutadiene. The sealants of the present invention maintain the excellent attributes of traditional polyurethane sealants, such as low water swell, low moisture vapor transmission, good adhesion to the window frame, low migration of the insulating gas, and good workability, but without the use of polyisocyanates in the curing process. The invention further relates to methods for sealing insulated glass panels with these rugged sealants, and the resulting insulated glass articles.

Insulated glass sealants currently available in the marketplace employ polyols, such as hydroxyl-terminated polybutadienes, which react with polyisocyanates to form a polyurethane sealant. Embodiments of the present invention, however, react acetoacetylated polymers, such as acetoacetylated polybutadienes, with cross-linking reagents having amino functionality instead of polyisocyanate. The acetoacetylated polymers are employed in the present invention as the continuous phase in the elastomeric sealant matrix because the hydrophobicity of the polymeric portion of the acetoacetylated polymer (e.g., polybutadiene) is advantageous to the final sealant. The use of polyetheramines, polyamines, or polyamides instead of polyisocyanate as a crosslinking agent, however, provides certain environmental, regulatory, and safety benefits. Additionally, the polybutadienes employed by the present invention are acetoacetyl functionalized instead of the hydroxyl-terminated polybutadienes more commonly used in insulated glass sealant technologies. “Acetoacetylated” means that an acetoacetyl group (CH₃COCH₂CO—) is present somewhere along the chain of the polymer, for example pendent to the backbone of the polymer chain or at the end of the polymer chain. In one embodiment, each end of the polymer bears an acetoacetyl group. In another embodiment, acetoacetyl groups are present only at the ends of the polymer chain.

The elastomer matrix of the present invention is formed by a process comprising reacting cross-linking reagents having amino functionality with acetoacetylated polymers. The acetoacetylated polymer preferably comprises a major component. The major component typically makes up at least 90% by weight of the acetoacetylated polymer and is selected from the group consisting of polymeric acetoacetylated substances, such as acetoacetylated polybutadienes, polyisoprenes, copolymers of butadiene with acrylonitrile, copolymers of butadiene with styrene, copolymers of isoprene with acrylonitrile, copolymers of isoprene with styrene, and mixtures of two or more of the above.

The sealants of the present invention maintain the excellent attributes of traditional polyurethane sealants, including low water swell, low moisture vapor transmission, good adhesion to the window frame, low migration of the insulating gas, and good workability, but without the use of isocyanates in the curing process. Because the present sealant employs compatible compositions which solidify at different rates and through different mechanisms, the present invention can be applied at a lower temperature than traditional hot melts, and also provides sufficient handling strength to the unit faster than traditional chemical-cure products, thereby combining the best properties of both the hot melt and chemically-curing technologies into a successful sealant for the insulated glass industry. The sealant of the present invention is designed to be applied at temperatures in the range of 70°-300° F., in the form of a liquid or paste which turns to a solid upon curing. The sealant of the present invention then cures chemically to provide a permanent elastomeric, temperature-resistant sealant which provides the structural integrity for the insulated glass unit.

As would be readily appreciated by one having ordinary skill in the art, the strength properties of the insulated glass sealants in the fluid phase, i.e., liquid or paste, can be controlled by the type and quantity of the acetoacetylated polymer and, optionally, any additives. Ultimate strength of the edge sealant is controlled by the type and cross-linked density of the cross-linking. Suitable acetoacetylated polymers generally have a glass transition temperature (Tg) of less than about 32° F. (0° C.). Suitable polymers useful as the polymeric portion of such acetoacetylated polymers including homopolymers and copolymers of dienes such as butadiene and isoprene as well as copolymers of one or more diene monomers with one or more non-diene monomers such as styrene and acrylonitrile. Furthermore, suitable hydrophobic acetoacetylated polymers include acetoacetylated polybutadienes, acetoacetylated polyisoprenes, acetoacetylated copolymers of butadiene with acrylonitrile, acetoacetylated copolymers of butadiene with styrene, acetoacetylated copolymers of isoprene with acrylonitrile, acetoacetylated copolymers of isoprene with styrene, and mixtures thereof. The acetoacetylated polymers preferably have a number average molecular weight in the range of 500 to 30,000. The number average molecular weight of the acetoacetylated polymers may be more specifically in the range of 750 to 25,000, and more preferably in the range of 1,000 to 20,000. The acetoacetylated polymers may, for example, be linear or branched. A branched acetoacetylated polymer may contain 3, 4, 5, 6 or even a greater number of ends (branches). The polymeric segments of these substances, if comprised of two or more different monomers, may be random, block, or tapered copolymers. Additionally, the polymers may contain any number of acetoacetyl groups per molecule, such as at least 2 or more acetoacetyl groups per molecule. The acetoacetyl (CH₃COCH₂CO—) groups may appear anywhere in the polymer, for example, pendent to the backbone of the polymer chain and/or, in a preferred embodiment, at each end of the polymer chain. In one aspect of the invention, the polymer bears acetoacetyl groups only at the terminal positions of the polymer chain. In one embodiment, the polymeric portion of the acetoacetylated polymer is saturated or essentially saturated. For example, if such polymeric portion is derived by polymerization of a diene monomer, the olefinic sites present may be hydrogenated. Mixtures of different acetoacetylated polymers may be employed if so desired.

Acetoacetylated polymers suitable for use in the present invention are available from commercial sources, such as Cray Valley USA, LLC.

A preferred acetoacetylated polybutadiene may be selected from those which are hydroxyl-terminated polybutadienes reacted with a stoichiometric amount of a diketene or diketene-acetone adduct, such as 2,2,6-trimethyl-4H-1,3-dioxin-4-one. Accordingly, the polymers may be utilized in the reaction process as acetoacetylated polymers directly or employed as hydroxyl-terminated polymers which are reacted with a diketene or diketene-acetone adduct to produce the acetoacetylated polymer. The reaction between the hydroxyl-terminated polymers and the diketene or diketene-acetone adduct may take place prior to the addition of the cross-linking reagent. The acetoacetylated polymer may also be prepared by any other method known in the art.

The embodiments of the present invention may utilize a myriad of suitable cross-linking reagents having amino functionality, such as polyetheramines, polyamines, and polyamides, and mixtures of two or more thereof. Specific polyetheramines that may be employed in the present invention include Jeffamine® T-3000 and T-403 manufactured by Huntsman Petrochemical Corporation. Specific polyamines may include ethylenediamine, diethylenetriamine, triethylenetetramine, tetraethylenepentamine, pentaethylenehexamine, hexamethylenediamine, methylpentamethylenediamine, trimethyihexanediamine, metaxylenediamine, spriro-acetal diamines, 1,3-[bisaminomethyl]-cyclohexane, tricyclodecanediamine, norbornanediamine, 3,3′-dimethylmethylene-di(cyclohexylamine), methylene-dicyclohexylamine, 1,2-cyclohexanediamine, isophoronediamine, meta-phenylenediamine and bis(hexamethylene)triamine. Polyamides having the following formula may also be used as a suitable cross-linking reagent:

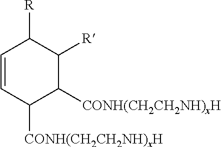

The cross-linking reagents preferably have an average functionality equal to, or greater than, 2. The sealants of the present invention include an elastomeric matrix having an amino: acetoacetate equivalent ratio. This equivalent ratio is provided by the cross-linking agent and by the acetoacetylated polymer, respectively. The preferable equivalent ratio of cross-linking reagent to acetoacetylated polymer is from about 0.9:1 to about 2:1. The equivalent ratio may be more specifically in the range of 1:1 to about 1.5:1, and more preferably in the range of 1.1:1 to about 1.4:1.

Suitable cross-linking reagents have at least 2 amino groups, preferably at least 3 amino groups in one molecule. The molecular weight of the cross-linking reagent is not limited, but preferably is within the range of 250 to 5,000. All reference to molecular weights herein is to number average molecular weights. The elastomeric matrix optionally may comprise components that do not participate in the crosslinking reaction. Among such “nonreactive” components, or additives, are comprised: fillers, plasticizers, stabilizers, pigments, fungicides, weatherability improvers, catalysts, and the like, as are known in the art. The strength properties of the insulated glass sealants in the fluid phase may also be affected by the type and quantity of additives. For example, a range of fillers may be selected by one of skill in the art and added in an amount sufficient to impart the appropriate strength to the liquid phase, as well as to impart desirable application properties to the sealant. One preferred filler is calcium carbonate. Other fillers can be used, as is known in the art. The sealant of the present invention should be easy to handle and apply to the insulated glass units. Any number of methods and equipment may be used to apply or provide the sealant to the insulated glass units, such as by spray, beading, or deposition.

The sealant of the present invention may be prepared in the following manner. For example, the acetoacetylated polymer(s) may first be disposed in a mixing vessel. The mixing vessel may be capable of carrying out mixing under a vacuum and may further include a mixer that comprises a variable speed, multi-shaft unit, having a low speed sweep blade, a high speed disperser, and a low speed auger. The filler, if utilized, may then be added to the polymer(s). Thereafter, the cross-linking reagent having amino functionality or mixtures thereof, may be added to the mixture subsequent to turning on the vacuum. At the point the cross-linking reagent is added, the mixing is conducted under vacuum so as to eliminate any exposure of the mixture to atmospheric conditions, and also to remove residual water from the raw materials, thereby improving the stability of the sealant. Small volume additives such as pigments, weatherability improvers and the like can be added before the introduction of the cross-linking reagent, or added thereafter. The elastomeric matrix is maintained under essentially dry conditions until such time as it is ready to be applied to the insulated glass unit. In other preferred embodiments, the mixing may be carried out under a blanket of dry, inert gas.

The insulated glass sealant of the present invention is applied to the insulated glass unit at temperatures of about 70°-300° F. in the form of a liquid or a paste. Thereafter the sealant cured gradually into a crosslinked solid. The sealant of the present invention is applied to the unit as a single material, therefore eliminating the need to combine several components together at the point of application.

The insulated glass sealants of the present invention may be utilized to produce an insulated glass unit. As would be appreciated by one having ordinary skill in the art, insulated glass units are generally configured to have a first glass sheet spaced apart from a second glass sheet by a spacer frame. The spacer frame generally has a base and two spaced apart legs joined to the base to provide a substantially U-shape. The space created by the spacer frame between the first and second glass sheets defines an interior annular space of the insulated glass unit. The spacer frame, which may be a flexible spacer frame, has a first side and a second side, with the first side located adjacent an inner-surface of the first glass sheet and the second side located adjacent the inner-surface of the second glass sheet. The insulated glass sealant is provided on, e.g., may be applied to, each side of the spacer frame to hold the glass sheets to the spacer frame. As discussed above, the sealant may function as a moisture barrier or moisture impervious material to prevent moisture from penetrating into the interior annular space of the unit. While this is a well-known configuration for insulated glass units, other configurations known to an ordinary skilled artisan may be utilized and are incorporated by the present invention.

The two glass sheets and may be clear glass, e.g., clear float glass, or one or both of the glass sheets and could be colored glass. Additionally, a functional coating, such as a solar control or low emissivity coating, may be applied in any conventional manner, such as MSVD, CVD, pyrolysis, sol-gel, etc., to a surface, e.g., an inner surface, of at least one of the glass sheets. The spacer frame itself may be a conventional rigid or box-type spacer frame as is known in the art. However, it is preferred that the spacer frame be a flexible-type spacer frame which may be formed from a piece of metal, such as 201 or 304 stainless steel, or tin plated steel and bent and shaped into a substantially U-shaped, continuous spacer frame. The spacer frame is adhesively bonded around the perimeter or edges of the spaced glass sheets and by the insulated glass sealant.

The insulated glass sealant may be applied to each side of the spacer frame to hold the glass sheets to the spacer frame. Additionally, or alternatively, the insulated glass sealant may be applied to each of the glass sheets. A number of methods may be employed to apply the sealant to the spacer frame and/or the glass sheets, as would be readily appreciated by one having ordinary skill in the art. For example, the sealant may be applied to the spacer frame as a continuous, non-continuous, uniform, or non-uniform bead. The sealant may similarly be applied to one or more of the glass sheets. The glass sheets may then be secured to the spacer frame by the sealant. As stated above, a number of other configurations and methods may be employed to seal the insulated glass unit with the insulated glass sealant.

As will be appreciated, the components of the insulated glass unit and spacer frame may be fabricated in any convenient manner, but are then modified as discussed herein to include the insulated glass sealant of the present invention. For example, a substrate, such as a metal sheet of 201 or 304 stainless steel having a thickness, length, and width sufficient for producing a spacer frame of desired dimensions, may be formed by conventional rolling, bending, or shaping techniques. Although the sealant may be provided on the substrate before shaping, it is generally preferred that the sealant be applied after the spacer frame is shaped. The insulated glass unit is assembled by positioning and adhering the glass sheets to the spacer frame by the sealant in any convenient manner. An insulating gas, such as argon or krypton, may be introduced in any convenient manner into the annular space created between the first and second glass sheets. The sealant material beads may act to attach the glass sheets to the spacer frame. The sealants of the present invention maintain the excellent attributes of traditional polyurethane sealants, including low water swell, low moisture vapor transmission, good adhesion to the window frame, low migration of the insulating gas, and good workability, but without the use of isocyanates in the curing process. Because the present sealant employs compatible compositions which solidify at different rates and through different mechanisms, the present invention can be applied at a lower temperature than traditional hot melts, and also provides sufficient handling strength to the unit faster than traditional chemical-cure products, thereby combining the best properties of both the hot melt and chemically-curing technologies into a successful sealant for the insulated glass industry.

It will be readily appreciated by an ordinarily skilled artisan that modifications may be made to the invention without departing from the concepts disclosed in the foregoing description. For example, although the exemplary embodiment described above utilized two glass sheets attached to the spacer, the invention is not limited to insulated glass units having only two glass sheets but may be practiced to make insulated glass units have two or more glass sheets, as are known in the art. Further, in at least one embodiment of the invention, the sealant may be used with a spacer frame having a generally U-shaped cross-section. The invention, however, may be used with a spacer having any type of cross-section. Similarly, the invention is described above as forming a sealant bead on the spacer, on one or more glass sheets, or both. A number of other application methods may be utilized, however, in addition to utilizing a sealant bead, as would be appreciated by a skilled artisan. Still further, the layers of the sealant may be applied or flowed onto the outer surface of the spacer and/or the glass sheets in any convenient manner, e.g., one or more layers. Accordingly, the particular embodiments described in detail herein are illustrative only and are not limiting to the scope of the invention, which is to be given the full breadth of the appended claims and any and all equivalents thereof.

### EXAMPLES

The present invention may be best understood in view of the following non-limiting examples.

Two samples of acetoacetylated polybutadiene polymer, Sample A and Sample B, were produced by first dehydrating hydroxyl-terminated polybutadiene sold by Cray Valley USA, LLC under the trade name Poly bd® R45HTLO under vacuum (<40 mm Hg) at 100-105° C. for 1.5 hours. The dehydrated polybutadiene was cooled to 70° C. under N₂ blanketing and combined with 2,2,6-trimethyl-4H-1,3-dioxin-4-one. The combined reactants were then heated for six hours at 130° C. with the last hour of heating being performed under vacuum (60 mm Hg). The samples and starting material, presented as the Standard, exhibited the following properties:

TABLE 1

| | Polybd | Acetoacetalytion products of Polybd | |
|---|---|---|---|
| | R45HTLO | R45HTLO | |
| | Standard | Sample A | Sample B |
| Tg, ° C. | −76.6 | −77.8 | −76.5 |
| Mn | 2768 | 3060 | 2902 |
| Mw | 6198 | 8285 | 7093 |
| MW polydispersity | 2.239 | 2.707 | 2.444 |
| Viscosity at 30° C. | 4743 | 4368 | 3993 |
| Appearance at | Clear, | Dark brown, hazy, | Dark brown, light |
| 23° C. | colorless, | viscous | hazy, viscous |
| | viscous | | |

The acetoacetylated polybutadiene produced as Sample A was then combined with polyetheramines in the relative weight amounts shown in Table 2. The polyetheramines employed were provided by Huntsman Petrochemical Corporation under the trade names Jeffamine® T-3000 and D-4000. Upon curing at various temperatures, the results observed were as follows:

TABLE 2

| | Example | | |
|---|---|---|---|
| | 1 | 2 | 3 |
| Acetoacetylated Polybd | 100 | 100 | 100 |
| R45HTLO | | | |
| Jeffamine T-3000 | 40.15 | 0 | 0 |
| Jeffamine D-4000 | 0 | 161 | 0 |
| Jeffamine D-4000 | 0 | 0 | 75.73 |
| Cured status at 23° C. | Cured well | Cured, soft | Not cured well |
| overnight | | | |
| Cured status at 80° C. | Cured well | Cured, soft | Cured, soft |
| overnight | | | |

According to Table 2, the acetoacetylated polybutadiene when combined with polyetheramines resulted in resins of acceptable quality when allowed to cure at room temperature overnight.

The acetoacetylated polybutadiene produced as Sample B was then combined with polyamines in the relative weight amounts shown in Table 3. The polyamines employed were provided by Sigma-Aldrich Co., LLC. The acetoacetylated polybutadiene produced as Sample B was also combined with a polyetheramine. The polyetheramine employed was provided by Huntsman Petrochemical Corporation under the trade names Jeffamine® T-403. Upon curing at various temperatures, the results observed were as follows:

TABLE 3

| | Example | | | | | |
|---|---|---|---|---|---|---|
| | 6 | 7 | 8 | 9 | 10 | 11 |
| Aceto- | 100 | 100 | 100 | 100 | 100 | 100 |
| acetylated | | | | | | |
| Polybd | | | | | | |
| R45HTLO | | | | | | |
| 1,6- | 4.40 | 2.20 | 0 | 0 | 0 | 0 |
| hexamethylene | | | | | | |
| diamine | | | | | | |
| Bis | 0 | 0 | 5.44 | 3.26 | 0 | 0 |
| (hexa- | | | | | | |
| methylene) | | | | | | |
| triamine | | | | | | |
| Jeffamine | 0 | 0 | 0 | 0 | 6.14 | 12.28 |
| T-403 | | | | | | |
| Cured status | Cured | Cured | Cured, | Cured, | Cured | Cured |
| at 23° C. | well | well | tacky | very | | |
| overnight | | | | tacky | | |
| Cured status | Cured | Cured, | cured | Cured, | Cured, | Cured, |
| at 80° C. | well | soft, | | tacky | soft | firmer |
| overnight | | tacky | | | | |

According to Table 3, the combination of acetoacetylated polybutadiene and polyamines achieved a cured resin comparable to cured products of Examples 1-3. The results suggest that the combination of acetoacetylated polymers with either polyetheramines or polyamines will yield cured resins of acceptable quality when allowed to cure at room temperature overnight.

A third batch of acetoacetylated polybutadiene was prepared using the same process used to produce Samples A and B. The third batch of acetoacetylated polybutadiene polymer was then combined with polyamines in the relative weight amounts listed in Table 4 to further evaluate the properties of the cured product. The observed results were as follows:

TABLE 4

| | Example | |
|---|---|---|
| | 12 | 13 |
| Acetoacetylated polybd R45HTLO (Sample C, eq wt = | 100 | 100 |
| 1320) | | |
| 1,6-hexamethylene diamine (eq wt per NH2 = | 4.4 | 0 |
| 58.1) | | |
| Bis(hexamethylene) triamine (eq wt per NH2 = | 0 | 5.44 |
| 71.8) | | |
| Tack-free time at 75° C. | <10 | — |
| Pot life at 75° C., minutes | <3 | <3 |
| Cured status at 75° C. overnight | good | good |

The results of Table 4 demonstrate that the combination of acetoacetylated polybutadiene and polyamines can cure to an acceptable extent at a relatively low process temperature in shorter amounts of time than the hot-melt butyl type and chemically cured thermoset sealants for insulated glass.

A fourth batch of acetoacetylated polybutadiene was prepared, Sample D. Sample D was prepared by combining Poly bd® R20LM, manufactured by Cray Valley USA LLC, with 2,2,6-trimethyl-4H-1,3-dioxin-4-one, manufactured by Sigma-Aldrich Co., LLC. The resulting acetoacetylated polybutadiene polymer was combined with previously employed polyetheramines and polyamines in the relative weight amounts listed in Table 5. The hardness of each product was tested by Shore durometer and the observed results and properties of the cured products were as follows:

TABLE 5

| | Example | | |
|---|---|---|---|
| | 14 | 15 | 16 |
| Acetoacetylated Poly bd R20LM (Sample D) | 100 | 100 | 100 |
| Jeffamine T-403 | 24.8 | 0 | 0 |
| 1,6-hexamethylene diamine | 0 | 9.18 | 0 |
| Jeffamine T-3000 | 0 | 0 | 168.07 |
| Cured situation | | | |
| @ 23° C. | good | curing too | good |
| | | fast to be | |
| | | mixed | |
| | | well | |
| @ 45° C. | good | curing too | good |
| | | fast to be | |
| | | mixed | |
| | | well | |
| Mechanical property looked | good | good | brittle |
| Hardness, Shore A | 52 | 22 | 40 |

As observed with the cured products in Examples 12 and 13, the results of the combination of acetoacetylated polybutadiene and polyetheramines, as provided in Table 5, produced a cured resin with acceptable properties for insulated glass sealant applications.

A further test was performed to analyze the moisture barrier properties of the sealant. The hydroxyl-terminated polybutadiene (Poly bd® R45HTLO resin) was mixed with 2,2,6-trimethyl-4H-1,3-dioxin-4-one at 130° C. for five hours to produce an acetoacetylated polybutadiene. After further mixing with a polyetheramine (Jeffamine® T-403), the solution was poured on an open mold to cure. The harvested elastomeric matrix sheet was then tested for water-vapor transmission (WVT). The elastomeric matrix sheet had a film thickness of 0.320 cm and an area of 50 cm². The sheet was loaded on a MOCON PERMATRAN-W model 3/33 tester at 73.4° F. (23° C.). Upon reaching equilibrium, the resulting transmission rate was 7.00 gm/[m²-day].

While preferred embodiments of the invention have been shown and described herein, it will be understood that such embodiments are provided by way of example only. Numerous variations, changes, and substitutions will occur to those skilled in the art without departing from the spirit of the invention. Accordingly, it is intended that the appended claims cover all such variations as fall within the spirit and scope of the invention.

The present invention, therefore, is well adapted to carry out the objects and attain the ends and advantages mentioned, as well as others inherent therein. While the invention has been depicted and described and is defined by reference to particular preferred embodiments of the invention, such references do not imply a limitation on the invention, and no such limitation is to be inferred. The invention is capable of considerable modification, alteration and equivalents in form and function, as will occur to those ordinarily skilled in the pertinent arts. The depicted and described preferred embodiments of the invention are exemplary only and are not exhaustive of the scope of the invention. Consequently, the invention is intended to be limited only by the spirit and scope of the appended claims, giving full cognizance to equivalents in all respects.

What is claimed is:

1. An insulated glass sealant comprising an elastomeric matrix that is the reaction product of an acetoacetylated polymer and a cross-linking reagent having amino functionality.

2. The insulated glass sealant of claim 1, further comprising one or more additives selected from the group consisting of inorganic fillers, plasticizers, and mixtures thereof.

3. The insulated glass sealant of claim 1, wherein the acetoacetylated polymer is hydrophobic.

4. The insulated glass sealant of claim 1, wherein the acetoacetylated polymer has a glass transition temperature (Tg) of less than about 32° F. (0° C.).

5. The insulated glass sealant of claim 1, wherein the acetoacetylated polymer contains a major component selected from the group consisting of acetoacetylated polybutadienes, acetoacetylated polyisoprenes, acetoacetylated copolymers of butadiene with acrylonitrile, acetoacetylated copolymers of isoprene with acrylonitrile, acetoacetylated copolymers of isoprene with styrene, acetoacetylated copolymers of butadiene and styrene, and mixtures thereof.

6. The insulated glass sealant of claim 1, wherein the elastomeric matrix has an equivalent ratio of cross-linking reagent to acetoacetylated polymer from about 0.9:1 to about 2:1.

7. The insulated glass sealant of claim 1, wherein the elastomeric matrix has an equivalent ratio of cross-linking reagent to acetoacetylated polymer from about 1:1 to about 1.4:1.

8. The insulated glass sealant of claim 1, wherein the acetoacetylated polymer has a number average molecular weight in the range of 500 to 30,000.

9. The insulated glass sealant of claim 1, wherein the acetoacetylated polymer has a number average molecular weight in the range of 1,000 to 20,000.

10. The insulated glass sealant of claim 1, wherein the elastomeric matrix has an equivalent ratio of cross-linking reagent to acetoacetylated polymer from about 1:1 to about 1.4:1 and the acetoacetylated polymer has a number average molecular weight in the range of 1,000 to 20,000.

11. The insulated glass sealant of claim 1, wherein the cross-linking reagent is selected from the group consisting of polyetheramines, polyamines, polyamides, and mixtures of two or more thereof.

12. The insulated glass sealant of claim 1, wherein the cross-linking reagent has an average functionality equal to, or greater than, 2.

13. A method of sealing an insulated glass unit comprising:
applying an insulated glass sealant to one or more glass sheets, a spacer to be disposed between the glass sheets, or both; and
contacting the one or more glass sheets with the spacer to define an annular space between the glass sheets and to produce the insulated glass unit;
wherein the sealant comprises an elastomeric matrix that is the reaction product of an acetoacetylated polymer and a cross-linking reagent having amino functionality.

14. The method of claim 13, wherein the sealant further comprises one or more additives selected from the group consisting of inorganic fillers, plasticizers, and mixtures thereof.

15. The method of claim 13, wherein the acetoacetylated polymer is hydrophobic and contains a major component selected from the group consisting of acetoacetylated polybutadienes, acetoacetylated polyisoprenes, acetoacetylated copolymers of butadiene with acrylonitrile, acetoacetylated copolymers of isoprene with acrylonitrile, acetoacetylated copolymers of isoprene with styrene, acetoacetylated copolymers of butadiene and styrene, and mixtures thereof.

16. The method of claim 13, wherein the sealant is applied as a bead to the one or more glass sheets, the spacer, or both.

17. The method of claim 13, further comprising prior to or concurrent with the contacting step, introducing an insulating gas into the annular space created between the first and second glass sheets, wherein the insulating gas is selected from argon or krypton.

18. An insulated glass unit comprising:
a first glass sheet having an inner surface and an outer surface;
a second glass sheet having an inner surface and an outer surface, wherein the first and second glass sheets are positioned such that said inner surfaces of the glass sheets are facing one another;
a spacer located between the first and second glass sheets, the spacer having a first side and a second side, with the first side of the spacer located adjacent the inner surface of the first glass sheet and the second side of the spacer located adjacent the inner surface of the second glass sheet; and
an insulated glass sealant connecting the first and second glass sheets to the spacer;
wherein the sealant comprises an elastomeric matrix that is the reaction product of an acetoacetylated polymer and a cross-linking reagent having amino functionality.

19. The insulated glass unit of claim 18, wherein the sealant further comprises one or more additives selected from the group consisting of inorganic fillers, plasticizers, and mixtures thereof.

20. The insulated glass unit of claim 18, wherein the acetoacetylated polymer is hydrophobic and contains a major component selected from the group consisting of acetoacetylated polybutadienes, acetoacetylated polyisoprenes, acetoacetylated copolymers of butadiene with acrylonitrile, acetoacetylated copolymers of isoprene with acrylonitrile, acetoacetylated copolymers of isoprene with styrene, acetoacetylated copolymers of butadiene and styrene, and mixtures thereof.

21. The insulated glass unit of claim 18, wherein the elastomeric matrix has an equivalent ratio of cross-linking reagent to acetoacetylated polymer from about 1:1 to about 1.4:1.

22. The insulated glass unit of claim 18, wherein the acetoacetylated polymer has a number average molecular weight in the range of 1,000 to 20,000.

23. The insulated glass unit of claim 18, wherein the first and second glass sheets and the spacer are configured to provide an annular space between the glass sheets and wherein the insulated glass unit further comprises insulating gas within the annular space.

24. A method of making the insulated glass sealant of claim 1, wherein the elastomeric matrix is formed directly from the reaction of the acetoacetylated polymer and the cross-linking reagent.

25. A method of making the insulated glass sealant of claim 1, wherein the elastomeric matrix is formed by first reacting a hydroxyl-terminated polymer with a diketene or diketene-acetone adduct to produce the acetoacetylated polymer; and then reacting the acetoacetylated polymer with the cross-linking reagent.

26. The method of claim 25, wherein the diketene-acetone adduct is 2,2,6-trimethyl-4H-1,3-dioxin-4-one.

27. The insulated glass sealant of claim 1, wherein the acetoacetylated polymer is itself a reaction product of a hydroxyl-terminated polymer and a diketene or diketene-acetone adduct.

28. The method of claim 27, wherein the diketene-acetone adduct is 2,2,6-trimethyl-4H-1,3-dioxin-4-one.
